(19) United States
(12) Patent Application Publication
(10) Pub. No.: US 2013/0007650 A1
(43) Pub. Date: Jan. 3, 2013

(54) SYSTEMS AND METHODS FOR PROVIDING A CONTROL SYSTEM FOR AIRCRAFT REFUELING TRUCKS

(75) Inventors: Mark Van Hoy, Julian, NC (US); Jason Wileman, Summerfield, NC (US); Cliff Darrow, Greensboro, NC (US); Tim Bullins, Madison, NC (US)

(73) Assignee: BETA FLUID SYSTEMS, INC., Reidsville, NC (US)

(21) Appl. No.: 13/490,923

(22) Filed: Jun. 7, 2012

Related U.S. Application Data
(60) Provisional application No. 61/494,243, filed on Jun. 7, 2011.

(51) Int. Cl. G06F 3/048

(52) U.S. Cl. 715/771

(57) ABSTRACT

According to various embodiments, apparatuses and methods for providing a control system for aircraft refueling trucks is provided. The control system is configured for facilitating remote troubleshooting of one or more safety mechanisms associated with a flow of liquid fuel from a refueling vehicle to an aircraft, and analyzes data to determine whether one or more parameters associated with the one or more safety mechanisms have been satisfied. Once determined, the control system may generate a status for one or more selectable status indicators associated with the one or more safety mechanisms and display a visual representation of a particular safety mechanism associated with the selected status indicator The visual representation may include an image representing at least a physical location of the particular safety mechanism relative to the refueling truck so as to facilitate remote troubleshooting of the particular safety mechanism.

### CROSS-REFERENCE TO RELATED APPLICATIONS

This application claims priority to U.S. Application Ser. No. 61/494,243, filed Jun. 7, 2011, which is hereby incorporated herein in its entirety.

### BACKGROUND

1. Field of Various Embodiments

Embodiments of the present invention relate generally to systems and methods for controlling operation of aircraft refueling trucks, and more particularly relate to apparatuses and methods for monitoring, controlling, and troubleshooting a variety of safety sensor indicators generally required to be satisfied prior to commencing refueling activities.

2. Related Art

Due to the volatile nature of aircraft fuel and in particular the transfer of such fuel between vehicles that may possess, amongst other things, some degree of electrostatic charge, aircraft refueling trucks are generally configured with any of a variety of safety mechanisms that operators must check and verify prior to commencing any refueling activities. Oftentimes, satisfaction of the safety mechanisms is a prerequisite for activation of the fuel pump that permits refueling to even occur. In another sense, satisfaction of the safety mechanisms ensures that operators adhere strictly to pre-established procedures and protocol, whether safety oriented or otherwise.

At present, various control systems exist for monitoring the status of any of a variety of sensors, which are often employed to monitor characteristics associated with the previously mentioned safety mechanisms. Such control systems often display a plurality of status indicators to an operator, thereby notifying the operator of whether certain safety criteria have, or alternatively have not, been satisfied. However, when issues (e.g., unsatisfied criteria) are identified by such control systems, operators generally receive limited, if any, guidance or insight as to how best to troubleshoot and rectify the same. Instead, most systems merely identify the existence of any issue, forcing operators to call remote, often third party help centers to seek additional troubleshooting assistance. As a result, inefficiencies arise in the refueling process and help centers are often inundated with a high volume of calls.

Thus, a need exists to provide systems and methods to assist and guide operators through satisfaction of the safety mechanisms required to commence refueling activities, and to, in particular, provide detailed troubleshooting instructions onsite, with limited or no third party assistance.

### BRIEF SUMMARY OF THE INVENTION

According to various embodiments of the present invention, a control system is provided for facilitating remote troubleshooting of one or more safety mechanisms associated with a flow of liquid fuel from a refueling vehicle to an aircraft. Various embodiments of the control system comprise one or more memory storage areas; and one or more computer processors. The one or more computer processors are configured for: (A) receiving and storing in the one or more memory storage areas data associated with one or more safety mechanisms; (B) using at least a portion of the data to determine whether one or more parameters associated with the one or more safety mechanisms have been satisfied; (C) generating a status for one or more selectable status indicators associated with the one or more safety mechanisms, the one or more selectable status indicators being based at least in part upon the determination of whether the one or more parameters have been satisfied; and (D) in response to receiving a selection of one of the one or more selectable status indicators, displaying a visual representation of a particular safety mechanism associated with the selected status indicator, wherein the visual representation comprises an image representing at least a physical location of the particular safety mechanism relative to the refueling truck so as to facilitate remote troubleshooting of the particular safety mechanism.

According to various embodiments of the present invention, a computer-implemented method is provided for facilitating remote troubleshooting of one or more safety mechanisms associated with a flow of liquid fuel from a refueling vehicle to an aircraft. Various embodiments of the method comprise: (A) receiving and storing data in one or more memory storage areas, said data comprising data associated with one or more safety mechanisms; (B) using at least a portion of the data to determine, via at least one computer processor, whether one or more parameters associated with the one or more safety mechanisms have been satisfied; (C) generating, via the at least one computer processor, a status for one or more selectable status indicators associated with the one or more safety mechanisms, the one or more selectable status indicators being based at least in part upon the determination of whether the one or more parameters have been satisfied; and (D) in response to receiving a selection of one of the one or more selectable status indicators, displaying a visual representation of a particular safety mechanism associated with the selected status indicator, wherein the visual representation comprises at least a physical location of the particular safety mechanism relative to the refueling truck so as to facilitate remote troubleshooting of the particular safety mechanism.

According to various embodiments of the present invention, a control system is provided for facilitating remote troubleshooting of one or more safety mechanisms associated with a flow of liquid fuel from a refueling vehicle to an aircraft. Various embodiments of the control system comprise one or more memory storage areas; and one or more computer processors. The one or more computer processors are configured for: (A) receiving and storing in the one or more memory storage areas data associated with one or more sensors; (B) using at least a portion of the data to determine whether one or more parameters associated with the one or more sensors have been satisfied; (C) generating a status for one or more selectable status indicators associated with the one or more sensors, the one or more selectable status indicators being based at least in part upon the determination of whether the one or more parameters have been satisfied; and (D) in response to receiving a selection of one of the one or more selectable status indicators, displaying a status of at least one or more relays, inputs, and outputs associated with at least one of a programmable logic controller (PLC) and an actuator sensor interface (AS-i) configured to communicate with the one or more sensors and facilitate a flow of liquid fuel.

### BRIEF DESCRIPTION OF THE SEVERAL VIEWS OF THE DRAWING(S)

The accompanying drawings incorporated herein and forming a part of the disclosure illustrate several aspects of the present invention and together with the detailed description serve to explain certain principles of the present invention. In the drawings, which are not necessarily drawn to scale:

FIG. 1 is a block diagram of an aircraft refueling truck control system according to various embodiments;

FIG. 2 is schematic block diagram of a control system according to various embodiments;

FIG. 3 is a view of a screen display of a home module of an operator interface according to various embodiments;

FIG. 3A is a view of an exemplary report display screen of an operator interface according to various embodiments;

FIG. 3B is a view of an additional exemplary report display screen of an operator interface according to various embodiments;

FIG. 4 is an exemplary flow chart of an operator interface according to various embodiments;

FIG. 4A is an additional exemplary flow chart of an operator interface according to various embodiments;

FIG. 5 is a view of a screen display of a status module of an operator interface according to various embodiments;

FIG. 6 is a view of an ignition key information screen according to various embodiments;

FIG. 7 is a view of an actuator sensor interface indicator screen display according to various embodiments;

FIG. 8 is a view of a PLC indicator screen display according to various embodiments;

FIG. 9 is a view of a help module screen display according to various embodiments;

FIG. 10 is a view of a fueling sub-module screen display according to various embodiments;

FIG. 11 is a view of a system sub-module screen display according to various embodiments;

FIG. 12 is a view of another home module screen display of an operator interface according to another embodiment;

FIG. 13 is a view of a first image screen display accessible via the screen display of FIG. 12;

FIG. 14 is a view of a second image screen display accessible via the screen display of FIG. 12;

FIG. 15 is a view of a third image screen display accessible via the screen display of FIG. 12;

FIG. 16 is a view of a fourth image screen display accessible via the screen display of FIG. 12;

FIG. 17 is a view of a problem diagnosis screen display according to various embodiments; and

FIG. 18 is a flow chart of an exemplary data collection plan according to various embodiments.

### DETAILED DESCRIPTION OF VARIOUS EMBODIMENTS

Various embodiments of the present invention will now be described more fully hereinafter with reference to the accompanying drawings, in which some, but not all embodiments of the invention are shown. Indeed, embodiments of the invention may be embodied in many different forms and should not be construed as limited to the embodiments set forth herein. Rather, these embodiments are provided so that this disclosure will satisfy applicable legal requirements. Unless otherwise defined, all technical and scientific terms used herein have the same meaning as commonly known and understood by one of ordinary skill in the art to which the invention relates. The term “or” is used herein in both the alternative and conjunctive sense, unless otherwise indicated. Like numbers refer to like elements throughout.

Apparatuses, Methods, Systems, and Computer Program Products

As should be appreciated, various embodiments may be implemented in various ways, including as apparatuses, methods, systems, or computer program products. Accordingly, the embodiments may take the form of an entirely hardware embodiment, or an embodiment in which a programmable logic controller (PLC) or other analogous processor is programmed to perform certain steps. Furthermore, various implementations may take the form of a computer program product on a computer-readable storage medium having computer-readable program instructions embodied in the storage medium. In such embodiments, any suitable computer-readable storage medium may be utilized including hard disks, CD-ROMs, optical storage devices, or magnetic storage devices.

Various embodiments are described below with reference to block diagrams and flowchart illustrations of apparatuses, methods, systems, and computer program products. It should be understood that each block of any of the block diagrams and flowchart illustrations, respectively, may be implemented in part by computer program instructions, e.g., as logical steps or operations executing on a processor in a computing system. These computer program instructions may be loaded onto a computer, such as a special purpose computer or other programmable data processing apparatus (e.g., a programmable logic controller (PLC)) to produce a specifically-configured machine, such that the instructions which execute on the computer or other programmable data processing apparatus implement the functions specified in the flowchart block or blocks.

These computer program instructions may also be stored in a computer-readable memory that can direct a computer or other programmable data processing apparatus (e.g., PLC) to function in a particular manner, such that the instructions stored in the computer-readable memory produce an article of manufacture including computer-readable instructions for implementing the functionality specified in the flowchart block or blocks. The computer program instructions may also be loaded onto a computer or other programmable data processing apparatus (e.g., PLC) to cause a series of operational steps to be performed on the computer or other programmable apparatus to produce a computer-implemented process such that the instructions that execute on the computer or other programmable apparatus provide operations for implementing the functions specified in the flowchart block or blocks.

Accordingly, blocks of the block diagrams and flowchart illustrations support various combinations for performing the specified functions, combinations of operations for performing the specified functions and program instructions for performing the specified functions. It should also be understood that each block of the block diagrams and flowchart illustrations, and combinations of blocks in the block diagrams and flowchart illustrations, could be implemented by special purpose hardware-based computer systems that perform the specified functions or operations, or combinations of special purpose hardware and computer instructions.

General Overview

In general, according to various embodiments of the present invention, apparatuses and methods are provided for controlling operation of aircraft refueling trucks. This may, in particular, include control systems, apparatuses, and methods for assisting an operator with the tasks of monitoring, controlling, and troubleshooting a variety of safety mechanisms that must generally be satisfied prior to conducting refueling activities. According to various embodiments, the safety mechanisms comprise any mechanical or electrical components that create or maintain a safe condition, along with any sensors and/or actuators associated therewith.

System Architecture

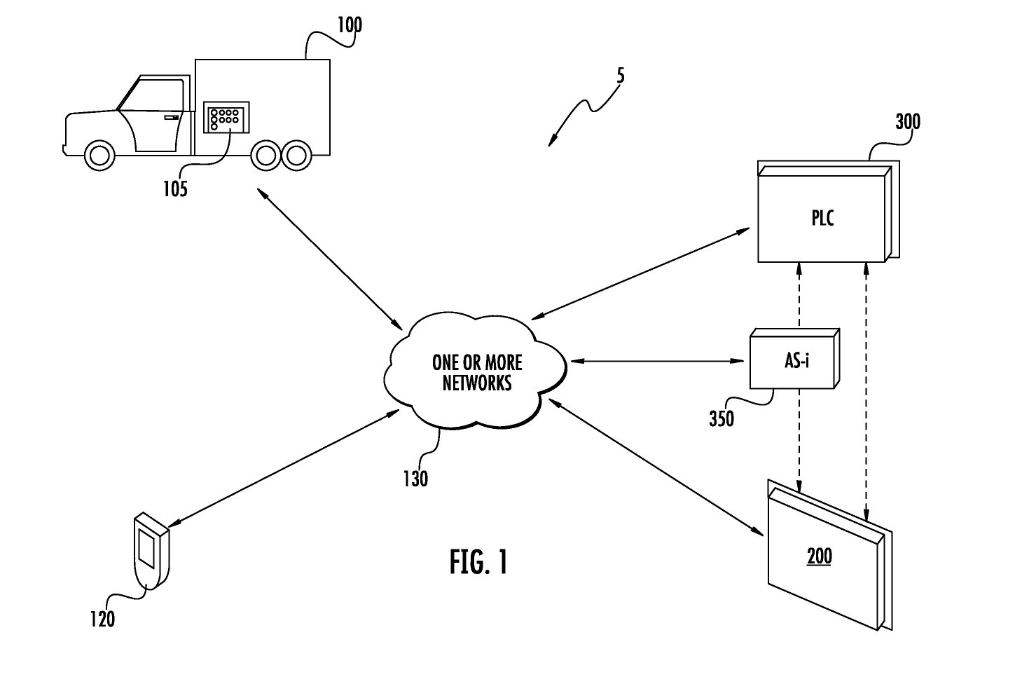

FIG. 1 provides an illustration of one type of an aircraft refueling truck system 5 that can be used in conjunction with various embodiments of the present invention. In the illustrated embodiment, the system 5 may include one or more networks 130, an operator handheld device 120, a control system 200, an actuator sensor interface (AS-i) 350, a programmable logic controller (PLC) 300, and an operator touch-screen panel 105 mounted on an aircraft refueling truck 100. While FIG. 1 illustrates the various system entities as separate, standalone entities, the various embodiments are not limited to this particular architecture.

According to various embodiments of the present invention, the one or more networks 130 may be capable of supporting communication in accordance with any one or more of a number of second-generation (2G), 2.5G, third-generation (3G), and/or fourth-generation (4G) mobile communication protocols, or the like. More particularly, the one or more networks 130 may be capable of supporting communication in accordance with 2G wireless communication protocols IS-136 (TDMA), GSM, and IS-95 (CDMA). Also, for example, the one or more networks 130 may be capable of supporting communication in accordance with 2.5G wireless communication protocols GPRS, Enhanced Data GSM Environment (EDGE), or the like. In addition, for example, the one or more networks 130 may be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones). As yet another example, each of the components of the system 5 may be configured to communicate with one another in accordance with techniques such as, for example, radio frequency (RF), Bluetooth™, infrared (IrDA), or any of a number of different wired or wireless networking techniques, including a wired or wireless Personal Area Network (“PAN”), Local Area Network (“LAN”), Metropolitan Area Network (“MAN”), Wide Area Network (“WAN”), or the like.

Although the operator handheld device 120, the control system 200, and the operator control panel 105 are illustrated in FIG. 1 as communicating with one another over the same one or more networks 130, these devices may likewise communicate over multiple, separate networks. For example, while the operator handheld device 120 may communicate with the control system 200 over a wireless personal area network (WPAN) using, for example, Bluetooth techniques, the operator control panel 105 may communicate with the control system 200 over a wireless wide area network (WWAN), for example, in accordance with EDGE, or some other 2.5G wireless communication protocol.

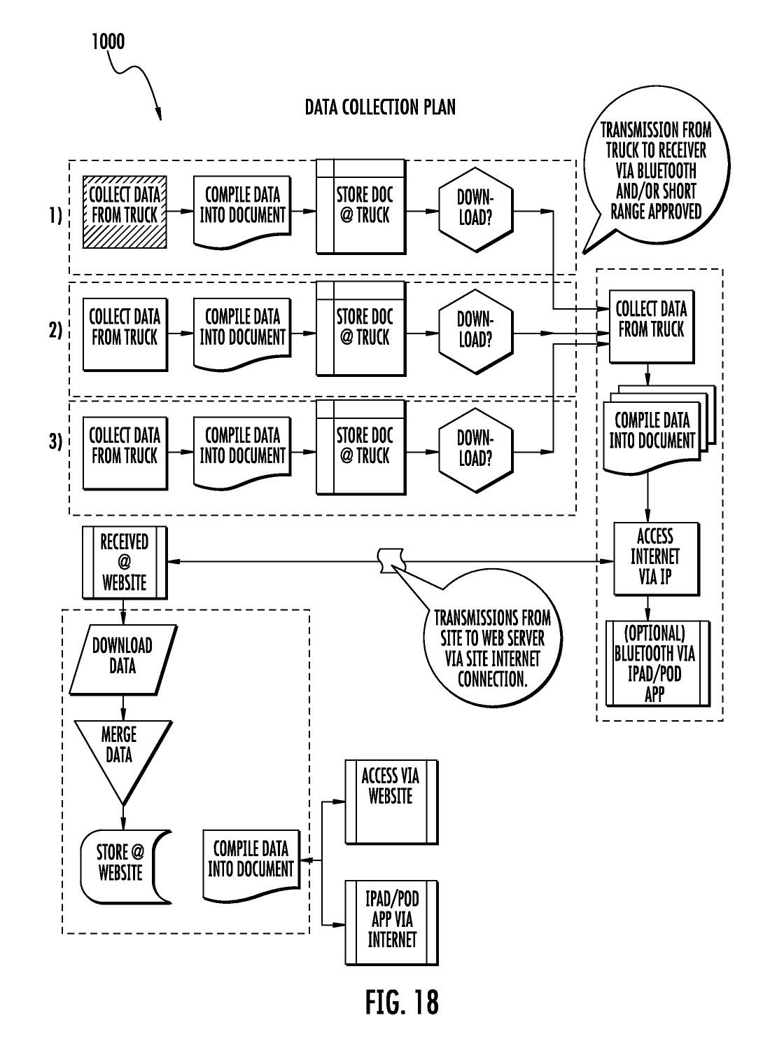

Further with regard to system communication and data collection, from FIG. 18, it should be understood that exemplary data collection plans 1000 may involve collection of data from one or more trucks (e.g., via the operator control panel 105 or a user interface, as described elsewhere herein) for subsequent distribution and/or access via one or more of the various networks referenced above. As may be seen from FIG. 18, the data collection process may collect, compile, store, and provide access to various data via any of a variety of human-machine interfaces (HMI) (e.g., graphical user interfaces (GUI)), which may be embodied on mobile applications, internet websites, or the like, as may be desirable for particular embodiments and as described further elsewhere herein.

Returning to FIG. 1, the operator handheld device 120 may be any of a variety of devices capable of receiving inputs from not only the control system 200 but also from the operator. In various embodiments, the operator handheld device 120 may be capable of receiving data via one or more input units or devices, such as a keypad, touchpad, interface card (e.g., modem, etc.) or receiver. The operator handheld device 120 may further be capable of storing data to one or more volatile or non-volatile memory modules, and outputting the data via one or more output units or devices, for example, by displaying data to the user operating the device, or by transmitting data, for example over the one or more networks 130.

The operator control panel 105, in various embodiments, may likewise be any device capable of receiving data via one or more input units or devices, such as a keypad, touchpad, interface card (e.g., modem, etc.), or receiver. The operator control panel 105 may further be capable of storing data to one or more volatile or non-volatile memory modules, and outputting the data via one or more output units or devices, for example, by displaying data to the user operating the panel 105, or by transmitting data, for example, over the network 130. In certain embodiments, the operator control panel 105 may be mounted to the aircraft refueling truck directly (e.g., inside the cab and/or to an external surface), as compared to the operator handheld device 120 which may be carried physically by the operator.

Control System Architecture

In various embodiments, the control system 200 includes various systems for performing one or more functions in accordance with embodiments of the present invention, including those more particularly shown and described herein. It should be understood, however, that the control system 200 might include a variety of alternative devices for performing one or more like functions, without departing from the spirit and scope of the present invention. For example, at least a portion of the control system 200, in certain embodiments, may be located on the operator handheld device 120 or the operator control panel 105.

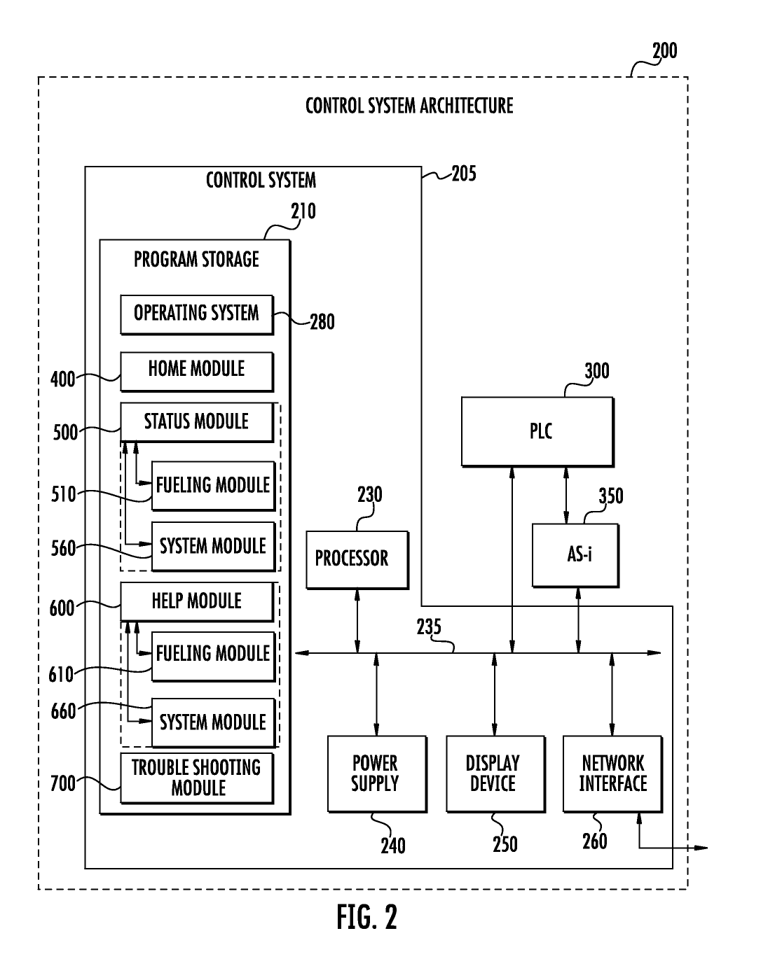

FIG. 2 is a schematic diagram of the control system architecture 200 that, according to various embodiments may include a control system 205, a programmable logic controller (PLC) 300, and an actuator sensor interface (AS-i) 350. As may be seen from FIG. 2, the control system 205 in certain embodiments may include a power supply 240 and one or more processors 230 that communicate with other elements via a system interface or bus 235. Also included in the control system 205 may be a display/input device 250 for receiving and displaying data, although in certain embodiments, the control system 205 may merely use the operator handheld device 120 and/or the operator control panel 105 as display/input devices. In those embodiments having a separate display/input device 250, such may be, for example, a keyboard or pointing device that is used in combination with a monitor.

Also located within the control system 205 may be a network interface 260 for interfacing and communicating with other elements via the one or more networks 130. It will be appreciated by one of ordinary skill in the art that one or more of the control system 205 components may be located geographically remotely from other control system components. Furthermore, one or more of the control system 205 components may be combined, and/or additional components performing functions described herein may also be included in the control system.

As further illustrated in FIG. 2, according to various embodiments, a number of program modules may also be located within the control system 205. The program modules may be stored by various storage devices 210. Such program modules may include in various embodiments an operating system 280, a home screen module 400, a status module 500, a help module 600, and a troubleshooting module 700. According to certain embodiments, these modules 400, 500, 600, and 700, direct certain aspects of the operation of the control system 205 with the assistance of the processor 230 and operating system 280. As will be described in further detail below, at least some of these modules may further include various sub-modules. For example, in at least one embodiment, the status module 500 and/or the help module 600 may be each configured with respective fueling sub-modules 510, 610 and system sub-modules 560, 660.

The system architecture 200 may, according to various embodiments, further include an actuator sensor interface (AS-i) 350 that provides an industrial networking solution for automation based systems that rely, at least in part, on programmable logic controller (PLC)-based or personal computer (PC)-based inputs. The AS-i 350 may be configured in certain embodiments so as to communicate, whether directly or indirectly, with both the control system 205 and the PLC 300. In at least one embodiment, the AS-i 350 may be configured to communicate with the control system 205 via the system interface or bus 235, as previously described herein, while in other envisioned embodiments, the AS-i may communicate over with any of a variety of system components via the network interface 260 and/or the one or more networks 130 (see FIG. 1).

The system architecture 200 may, according to various embodiments, additionally include a programmable logic controller (PLC) 300, which may serve to operatively connect the control system 205 and/or AS-i 350 to any of a variety of sensors (not shown) that may be used to monitor and control certain devices on the aircraft refueling truck. As a non-limiting example, the PLC 300 may operatively connect a proximity sensor associated with an over wing nozzle on a truck with the control system 205 and/or AS-i 350, such that an operator may be notified as to whether the nozzle is correctly positioned adjacent the aircraft, as will be described in further detail below. Such PLCs 300, as commonly known and understood in the art, may similarly operate electric motors, pneumatic or hydraulic cylinders, magnetic relays, solenoids, or analog outputs, while also providing a human-machine interface (HMI) (e.g., a graphical user interface (GUI)) for configuration, alarm reporting, and everyday control and operation. Such PLCs 300 may also communicate with the control system 205, the AS-i 350, and/or the operator handheld device 120 via any combination of the networks 130, system interface or bus 235, and/or the one or more networks 130, as each has been previously described herein.

Home Screen Module 400

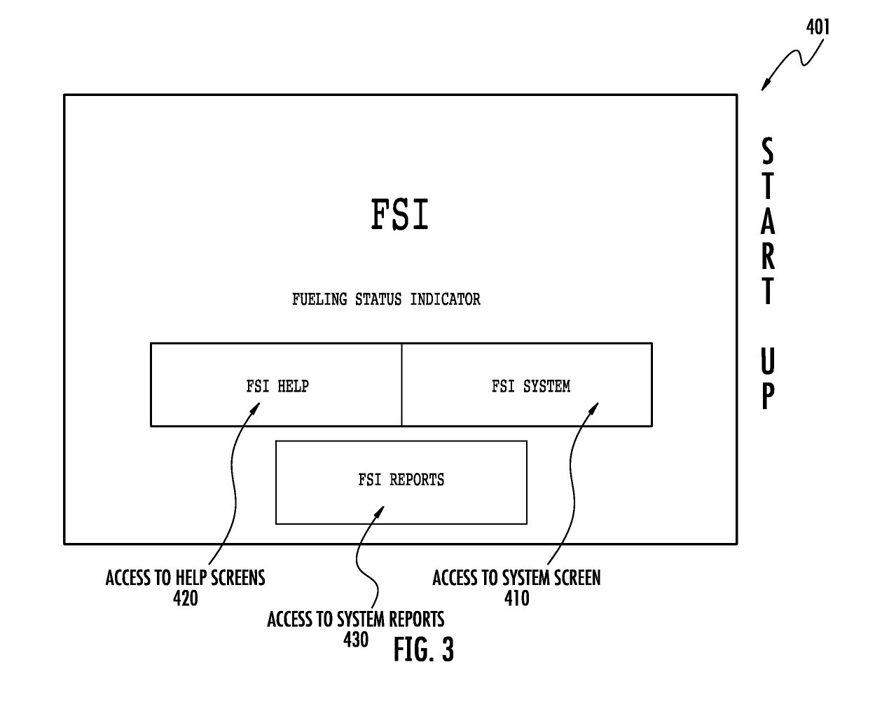

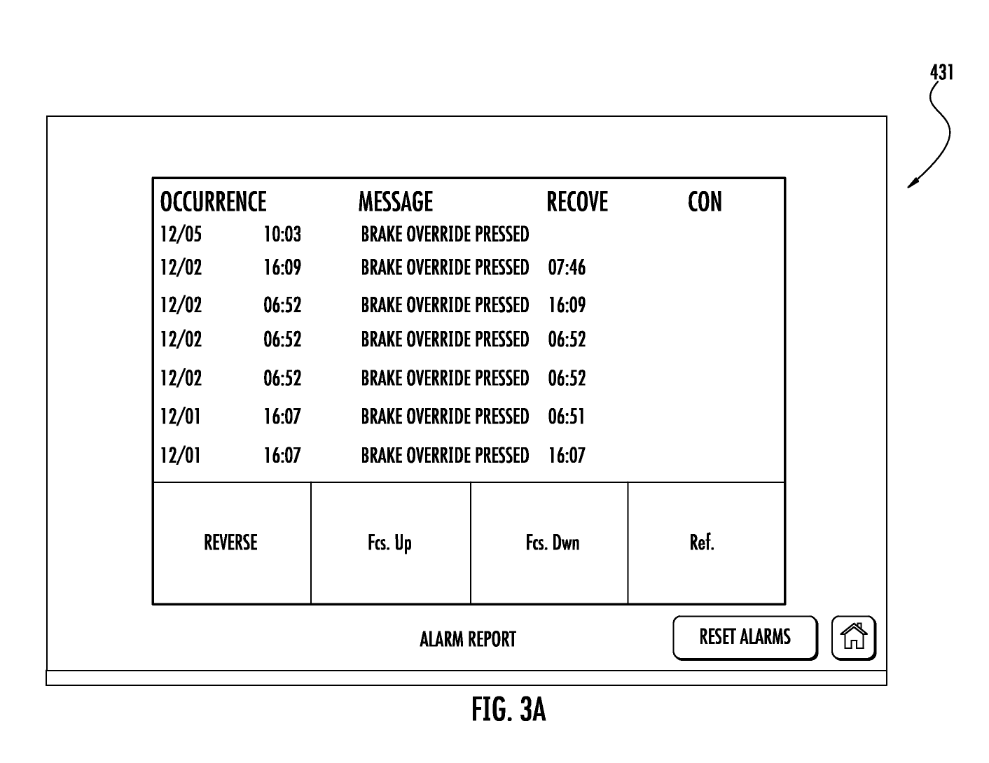

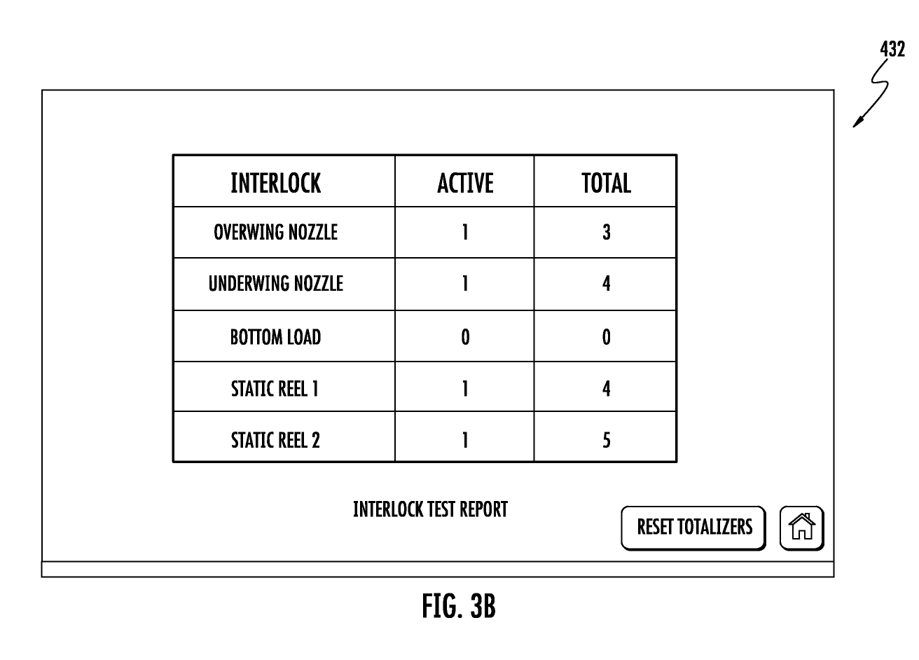

FIG. 3 is a view of a screen display 401 of the home module 400 according to various embodiments, as it may be displayed on, for example, the operator handheld device 120. In certain embodiments, the screen display 401 of the home module 400 may appear automatically upon startup of the operator handheld device 120 and/or the operator control panel 100. In other embodiments, the operator may need to access the home screen display 401 via one or more additional screens (not shown) when performing a pre-established procedure for commencing refueling activities.

In various embodiments, the screen display 401 of FIG. 3 may generally include at least two selectable (e.g., touch sensitive or touchpad or any of a variety of similarly configured, as commonly known and understood in the art) buttons, 410 and 420. In certain embodiments, the first of these buttons, 410, may be configured to communicate with the status module 500, such that when an operator touches, presses, or otherwise activates the button 410, a screen display associated with the status module appears, as will be described in further detail below. In these and still other embodiments, the second button 420 may be similarly configured to communicate with the help module 600, such that when the operator touches, presses, or otherwise activates the second button 420, a screen display associated with the help module appears, as will be described in further detail below. It should be appreciated that such touch-screen (and otherwise activated) buttons are commonly known and understood in the art as providing a user interface for controlling and manipulating any of a variety of screens displayed via a control system GUI.

In various embodiments, the screen display 401 of FIG. 3 may be further configured with one or more additional buttons, as may be desirable for particular applications, in which selective access to a variety of additional data may be desirable. As a non-limiting example, as further illustrated in FIG. 3, one such additional button 430 may be configured to access one or more reports generated by and/or accessible via the system 5. FIG. 3A illustrates one such exemplary report, namely an Alarm Report 431, displayable on a separate and distinct screen display. Of course, in other embodiments, the Alarm Report 431 may be configured as a “pop-up” window, or otherwise, as may be desirable for particular applications. As may be seen, however, the Alarm Report 431 may provide a user access to data regarding actions (e.g., over time) that have triggered one or more alarms. In the illustrated Alarm Report 431, pressing of a brake override has triggered an alarm message over the course of a five day period. FIG. 3B illustrates an additional exemplary report, namely an Interlock Test Report 432, which may be configured to inform a user of the number of active and/or total safety devices (e.g., nozzles, static reels, bottom loads, etc.) associated with the system 5. It should be understood, however, that in these and still other embodiments, any of a variety of reports may be available via the report button 430 of the home screen display 401, as may be desirable for particular applications.

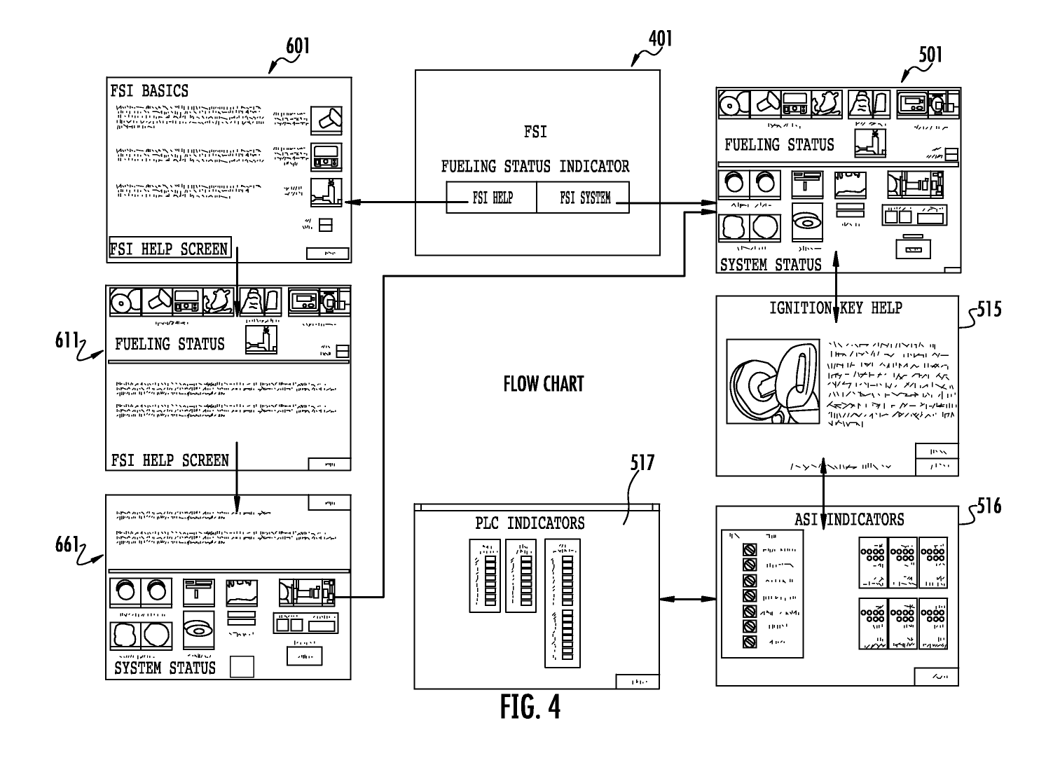

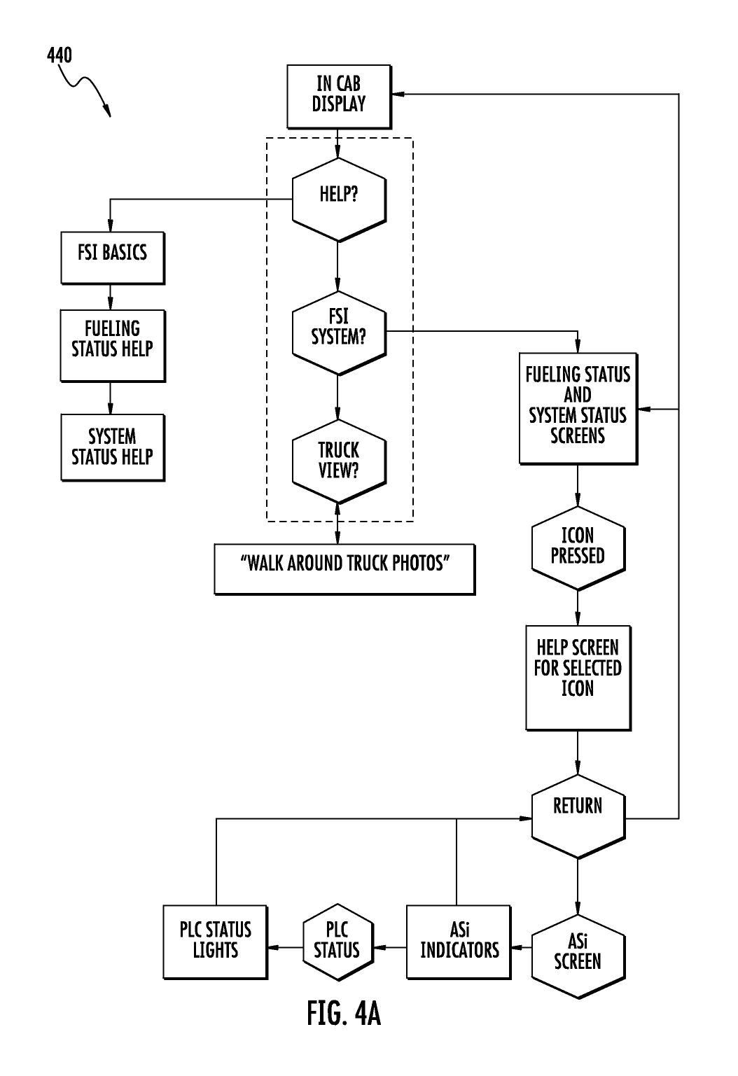

Turning to FIGS. 4 and 4A, representative flow charts 440 according to various embodiments are provided that depict the logic flow employed for communication between the various program modules located within the control system 205. It should be understood that this logic flow may in certain embodiments be conducted automatically, by the control system 205 in response to detection of any issues relating to devices needing attention prior to commencing refueling activities, as will be described in further detail below. In other embodiments, at least a portion of the logic flow may be conducted manually, such as for example by an operator when conducting a routine check of safety mechanisms in advance of commencing aircraft refueling procedures.

As may be best understood from FIGS. 4 and 4A, an operator, when preparing to transfer fuel from a refueling truck to an aircraft may, according to various embodiments, access the status module 500 via the home screen display 401. In certain embodiments, when such occurs, a screen display 501 of the status module 500 appears. In these and still other envisioned embodiments, the screen display 501 may likewise contain a plurality of selectable (e.g., touch activated) icons, each representing a single safety mechanism and/or sensor associated therewith, as will be described in further detail below.

From the screen display 501 of the status module 500, the operator may, according to various embodiments, select one of the plurality of icons, as necessary, to obtain further information regarding the status of a particular safety mechanism or associated sensor. When such is done, an individual information screen 515 appears, detailing what criteria must be met for satisfying a particular safety mechanism (e.g., for it to be “ready” to commence refueling activities). For example, as shown in the exemplary screen 515 of FIG. 4, information is provided according to certain embodiments as to the location of the ignition switch in the truck, following by instructions regarding whether the key must be “on” or “off” when seeking to begin fuel pumping. In still other embodiments, as will be described in further detail below, additional information screens 515 may be provided for any of a variety of devices or associated sensors, such that the operator may assess each, as necessary, in advance of commencing refueling.

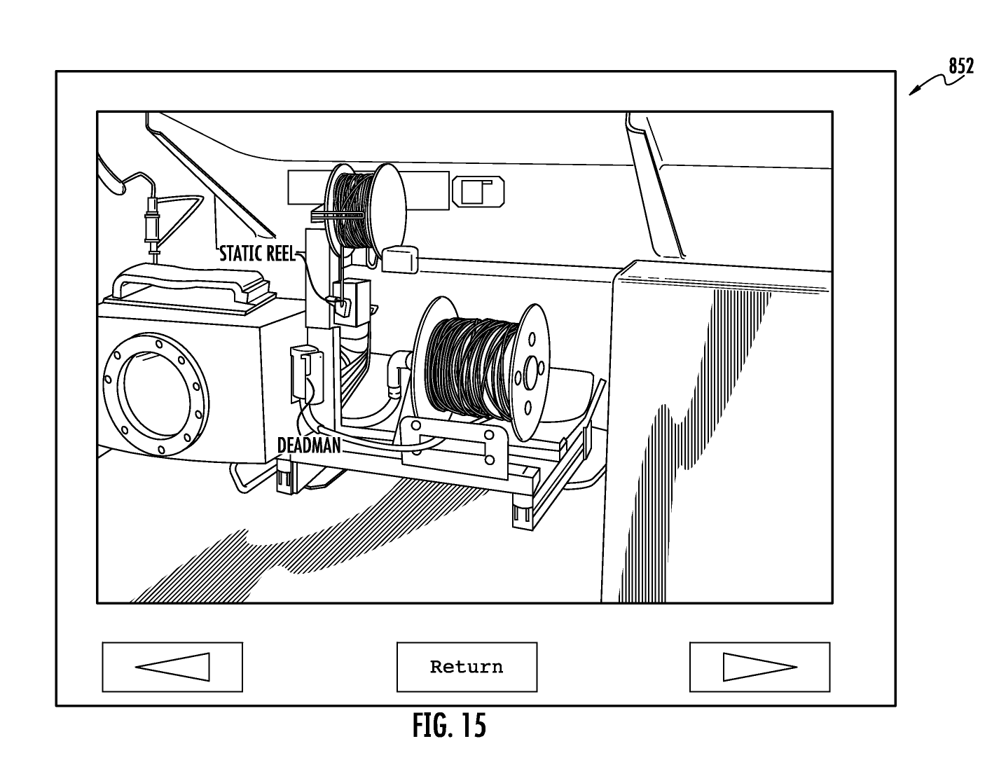

Remaining with FIGS. 4 and 4A, it may be understood that the operator, if desiring detailed information to troubleshoot a particular item's status (e.g., the ignition key, as shown), may according to various embodiments select an icon on the information screen 515 that opens a separate AS-i Indicators screen 516. The AS-i Indicators screen 516 provides further in-depth information regarding the status of individual modules, together with their respective inputs and outputs, thereby enabling the operator to analyze a particular problem or issue on his or her own. As may be seen, in at least some embodiments, a complementary PLC Indicators screen 517 may also be accessed by the operator to obtain additional information regarding relationships between specific PLC inputs, outputs, and relays and the item encountering issues (e.g., the ignition key). This enables the operator to troubleshoot problems as they arise, whether inadvertently or not, without having to resort to seeking third party (e.g., help center) assistance. Still other envisioned embodiments, as will be described in further detail below, may include additional troubleshooting screens depicting the location of particular devices on a refueling truck, as shown in, for example, FIG. 15.

Returning to FIGS. 4 and 4A, an operator, when conducting final checks and procedures in advance of transferring fuel may, according to various embodiments, not only access information screens regarding safety mechanisms and the like, but also a general help screen 601. Such may, for example, be particularly useful for purposes of training, or alternatively retraining, operators regarding new and/or revised safety procedures and processes. In certain embodiments, the general help screen 601 may, as previously discussed for similar screens, contain a variety of selectable (e.g., touch activated) icons, permitting an operator to access and view further detailed information on additional screens. In at least one embodiment, such additional screens may include a fueling status screen 611 and a truck system status screen 661, each associated with useful information for an operator needing to access the status module 500 and the help module 600, as described in further detail below.

Status Module 500

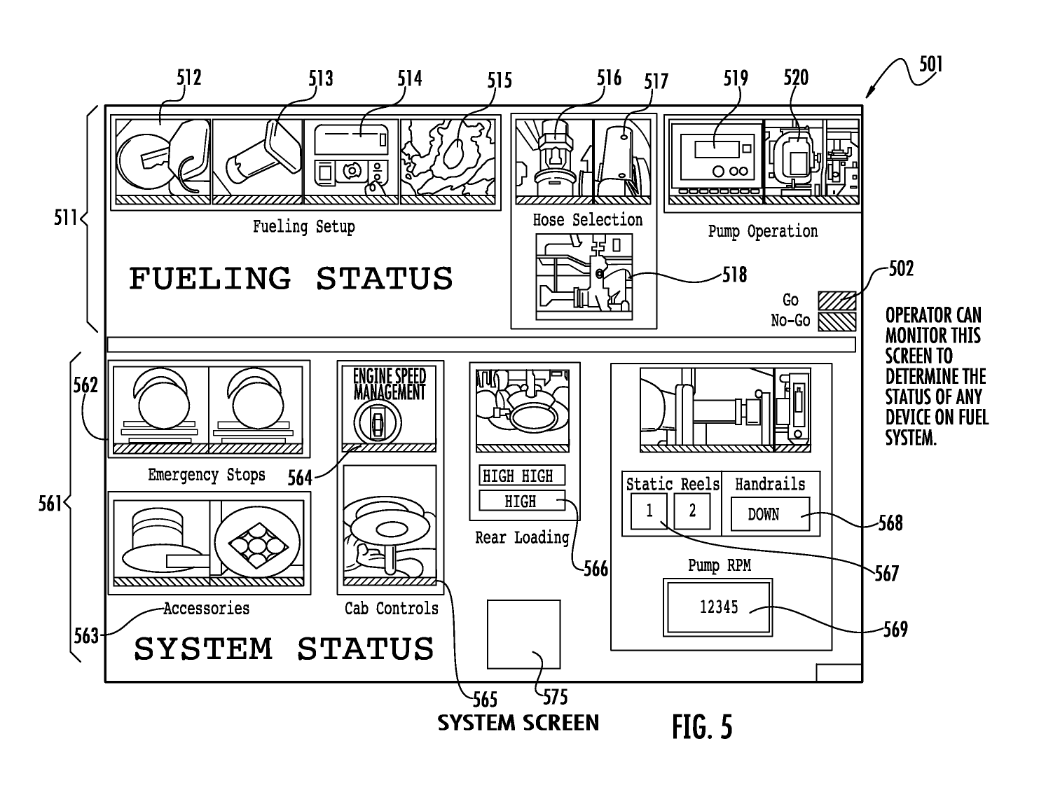

FIG. 5 is a view of a screen display 501 of the status module 500 according to various embodiments. As may be best understood from FIG. 5, the screen display 501 may include various portions, including the non-limiting examples of a fueling status screen 511 and a truck status screen 561. In certain embodiments, the fueling status screen 511 may display information regarding any of a variety of safety mechanisms that are monitored and controlled by the fueling sub-module 510 of the status module 500. Similarly, the truck status screen 561 may, in these and other embodiments, display information regarding any of a variety of safety mechanisms, which are monitored and controlled by the system sub-module 560.

Remaining with FIG. 5, it may be understood that the screen display 501 of the status module 500 may further, according to various embodiments, include a plurality of color-coded status indicators 502, each of which convey to an operator the status of a particular device or sensor associated with the status indicator. In certain embodiments, as illustrated, each of the color-coded status indicators 502 is associated (e.g., positioned adjacent) with one of a plurality of selectable (e.g., touch-sensitive) icons, 512-520 that depict the particular safety mechanism and/or sensor being monitored or controlled by the system 5. In this manner, the color-coded status indicators 502 provide a readily discernable “status” for each icon item, 512-520, based upon which the operator may further investigate items indicated as “not ready” for commencing refueling activities. In certain embodiments, the “not ready” status may indicate that certain procedural steps have not yet occurred so as to properly prepare a safety mechanism for use during refueling, while in other embodiments, the “not ready” status may indicate that the safety mechanism (and/or a sensor associated therewith) is malfunctioning or not configured correctly. In at least one embodiment, the “not ready” status may be displayed not only when a sensor associated with a safety mechanism is malfunctioning, but also when the sensor is not corrected hooked up to the PLC or the AS-i (e.g., if the wires are crossed, not plugged into the correct port, disconnected, etc.), as will be described in further detail below.

As may be understood from FIG. 5, in various embodiments, when a safety characteristic related to, for example, activation of the ignition key has not been satisfied, the system 5 may be configured such that the status indicator 502 adjacent the ignition key activation icon 512 will turn red, or some alternative color-scheme commonly known and understood to signify that the device is “not ready” for fueling to commence. In certain embodiments, when the safety mechanism characteristic is not satisfied, an audible alert (not shown) may also be transmitted by the status module 500, together with the visual-based status indicator 502 of the same. In these and still other embodiments, the status indicators 502 may be configured to turn green (or alternatively, another appropriately coded color) to signify that a particular icon item is “ready” for fueling to commence. In still other embodiments, an overall status indicator (not shown) may be included on the screen, displaying whether or not all devices and/or associated sensors have been satisfied. In at least some of such embodiments, only when such an overall status indicator is green (or otherwise indicative that all devices are ready or that all checks are complete) may actual refueling activities commence.

In various embodiments, the selectable icon items (e.g., 512-520) may represent any of a variety of commonly known safety mechanisms. The safety mechanisms comprise any mechanical or electrical components that create or maintain a safe condition, along with any sensors and/or actuators associated therewith. In certain embodiments, the icon items 512-520 may individually represent the non-limiting safety mechanisms of: an ignition key activation sensor icon 512, a parking brake activation sensor icon 513, an Inductance/Capacitance/Resistance (LCR) meter sensor icon 514, a hose selection sensor icon 516, a hose & nozzle proximity sensor icon 517, a fuel pump pressure sensor icon 519, a fuel pump liquid sensor icon 520, and a static reel icon 567. It should be understood that the system 5 may according to various embodiments display a status for each of the devices associated with these icons by way of a status signal transmitted, for example, from the PLC 300 operatively controlling a particular device to the AS-i 205, and in particular the status module 500 of the AS-i.

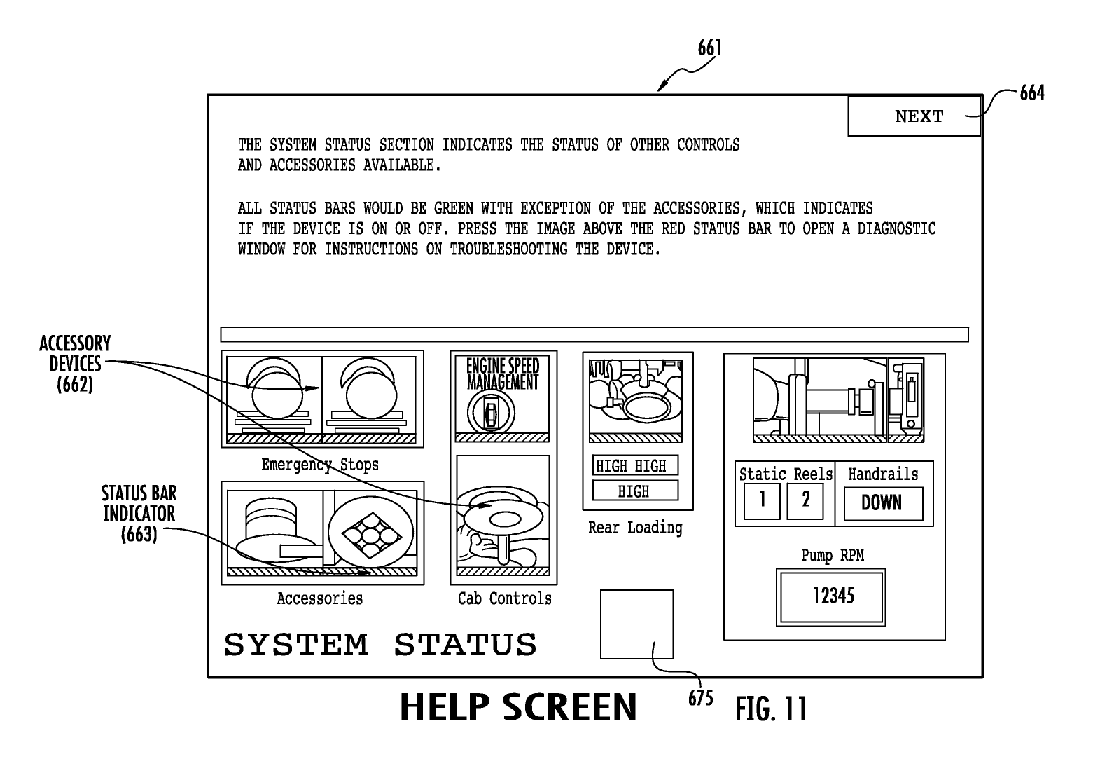

As further illustrated by FIG. 5, the screen display 501 of the status module 500 may according to various embodiments further include a logo icon 575, which may be customizable by any of a variety of customers using the system 5 so as to display any of a variety of corporate entity (or otherwise) logos, as may be generally desired for a particular application. Other embodiments may further include similar logo icons (e.g., icon 675, as shown in FIG. 11) on one or more of the screen displays of the various modules of the system 5. While depicted in at least FIGS. 5 and 11 as a square-shaped icon, it should be understood that any of a variety of logo shapes, sizes, and/or configurations may be accommodated, according to still further envisioned embodiments.

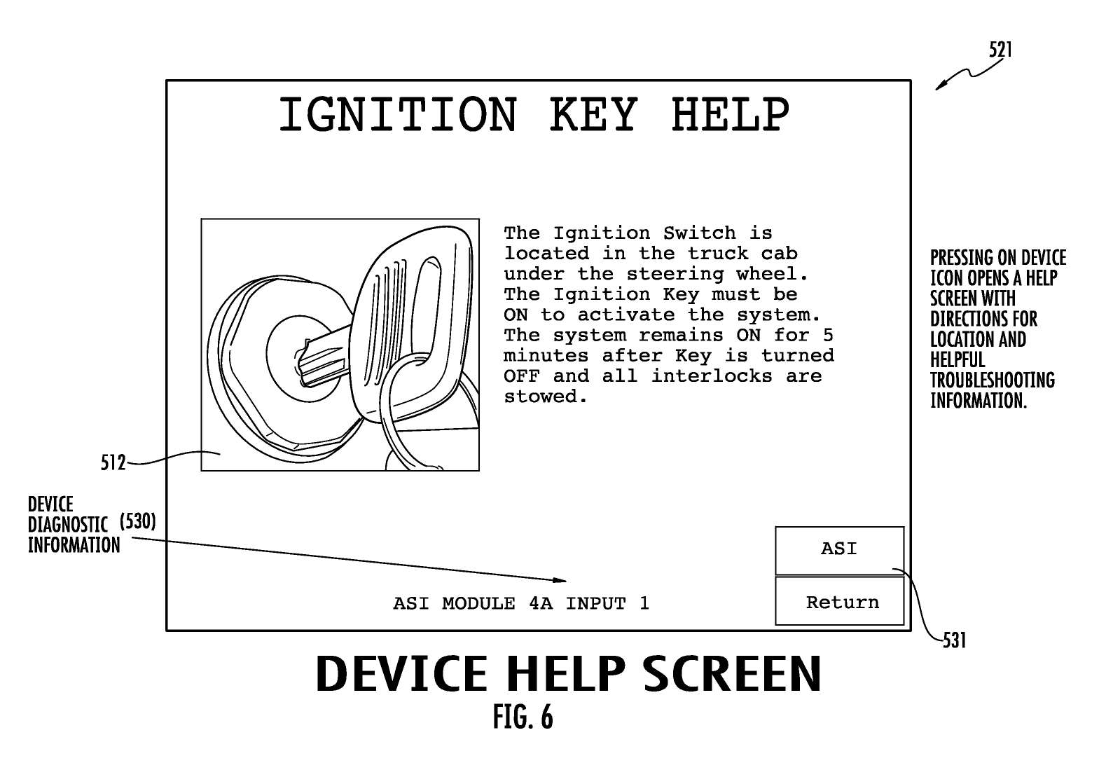

Turning to FIG. 6, it should be understood that the system 5 according to certain embodiments may be configured such that selection of any of the icon items 512-520 leads an operator to a new screen, such as the non-limiting example of an ignition key information screen 521. In at least one embodiment, the ignition key information screen 521 may be configured to provide the operator with detailed information regarding what conditions are necessary for satisfying the particular safety characteristics that will enable the device (e.g., the ignition key) to become “ready” for fueling to commence. Such enables the operator to personally troubleshoot a variety of conditions, as necessary, to achieve refueling conditions without having to contact a third party (e.g., a help center) for assistance.

Returning to FIG. 5, as a non-limiting example, it can be seen that the parking brake activation icon 513 is accompanied by a green status indicator 502, conveying to the operator, via the fueling sub-module 510, that the safety parameters associated therewith (e.g., that the brake has been set prior to commencing fueling) have been satisfied. On the other hand, while the hose selection icon 516 indicates that an over-wing nozzle has been properly chosen for a particular refueling, the proximity sensor associated therewith (not shown) has conveyed to the status module 500 that the selected nozzle has not yet been operatively connected to the airplane. As such, the status indicator 502 adjacent the proximity sensor icon 517 appears as red, or “not ready” to commence refueling. Of course, in still other embodiments, even if the correct nozzle has been selected, if the proximity sensor associated therewith (not shown) malfunctions and/or is not correctly hooked up to the PLC or the AS-i, as described elsewhere herein, the icon 517 will likewise appear as “not ready” (e.g., red, or similarly color-coated, also as described elsewhere herein) for refueling to occur.

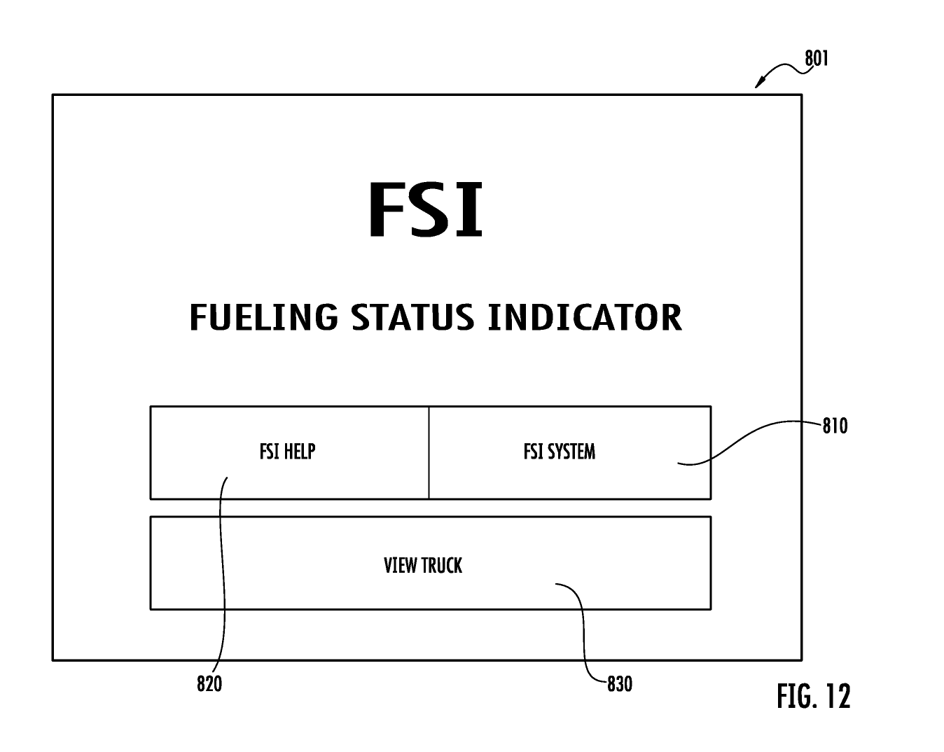

Remaining with FIG. 5, it should be understood that in various embodiments, the status of particular safety devices may be displayed in any of a variety of manners. As another non-limiting example, it can be seen that both static reel icons (collectively, 567) may be, according to various embodiments, configured to themselves turn green when ready and red when not. In other embodiments, the color-coding may be of any of a variety of color schemes (other than green and red) if desired, provided such generally convey to an operator that the device is “safe” and ready (versus not). Returning to the static reel icons 567, it can been seen that according to various embodiments, when the reels are properly deployed from the refueling truck to bond the aircraft seeking refueling to the truck, a sensor associatively connected to the static reel itself communicates to the status module 500 (e.g., via the PLC 300 and the AS-i 205) that the reels are in a safe position for refueling to commence. Alternatively, when the static reels remain un-deployed, the static reel icons 567 may, according to certain embodiments, indicate that it is not safe to commence refueling. In still other embodiments, the icon may be red even though the reels themselves are deployed, at which time an operator may access a troubleshooting module 700 (see FIG. 12) to further troubleshoot the system, as will be described in further detail below.

The above-discussed selectable icon items (e.g., 512-520) according to various embodiments generally relate to safety mechanisms controlled or monitored by the fueling sub-module 510 and corresponding to the preparatory conditions necessary for commencing the refueling process itself. However, in certain embodiments, namely those in which the status module 500 further comprises a truck status sub-module 560, the screen 501 may be configured to display a plurality of similarly-configured selectable icons (e.g., 562-569) on the truck status screen 561 portion of the screen. In these and other envisioned embodiments, these additional selectable icons may represent safety devices and/or conditions on the truck itself that must be satisfied for “safe” refueling to occur. In various embodiments, the additional selectable icons may include the non-limiting examples of safety mechanisms of: one or more emergency stop button icon 562, accessory (e.g., truck lights, sirens, etc.) status icon 563, truck engine management control icon 564, truck cab control icon 565, truck rear loading level indicator 566, static reel attachment status icon 567, handrail location indicator 568, and pump RPM indicator 569.

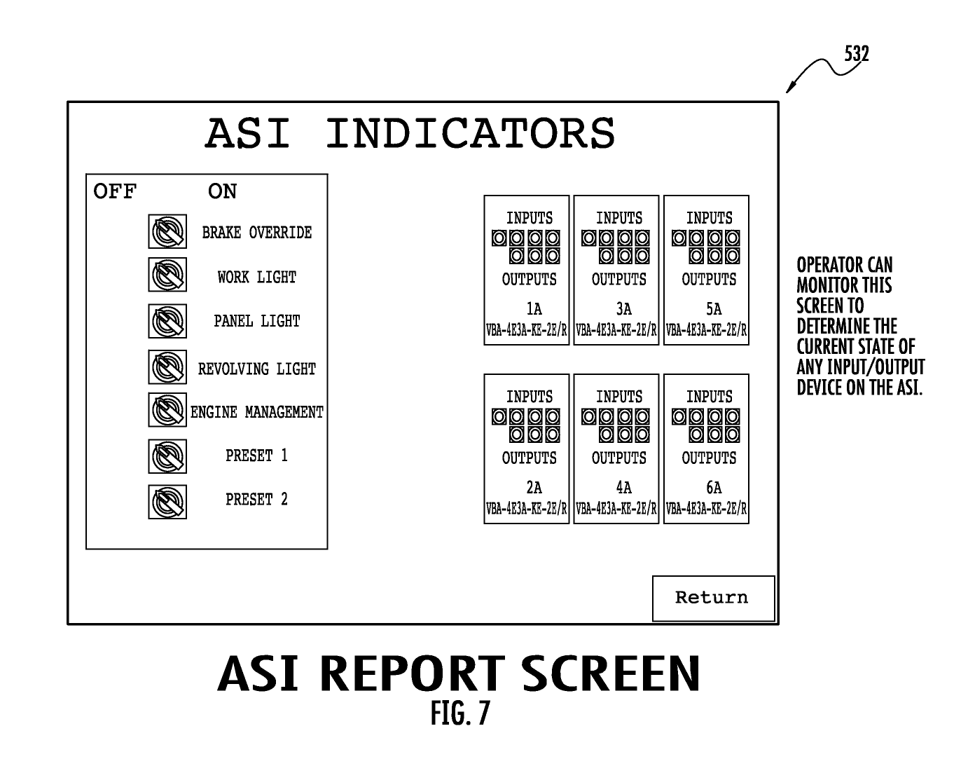

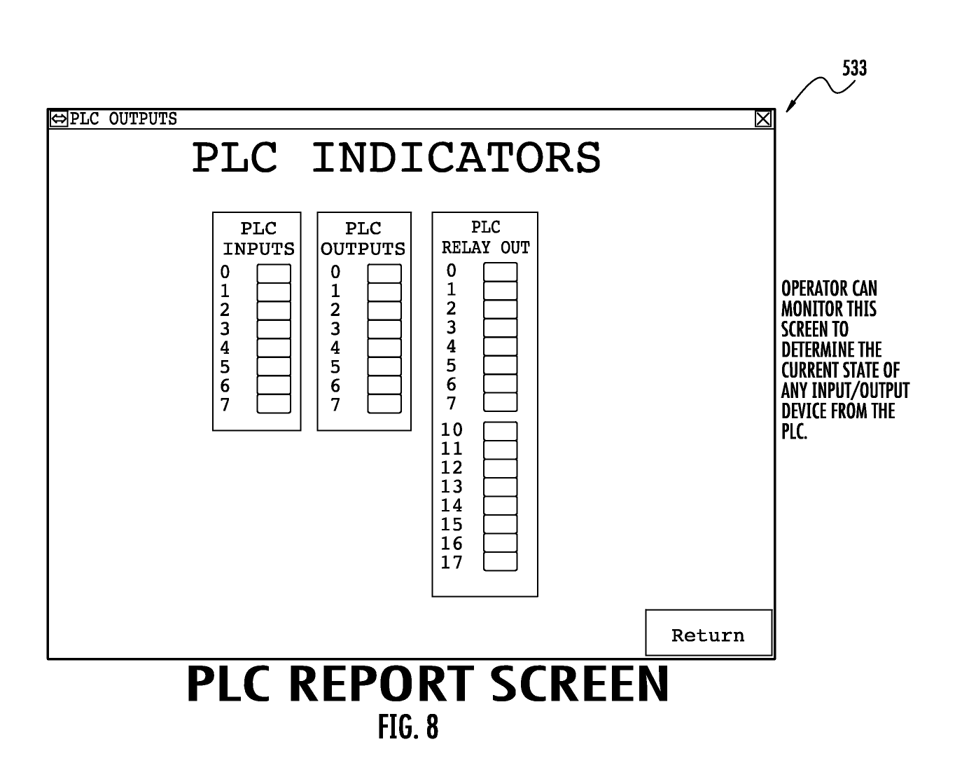

Returning for a moment to FIG. 6, as previously described, each of the selectable icons (e.g., 512-520 and 562-569) may be configured according to various embodiments with an adjacently positioned status indicator 502 and to be touch (or otherwise) selectable. In such embodiments, when selected, each of the icons may be configured to lead an operator to a more detailed information screen, such as that shown in FIG. 6 for ignition key activation 521. In certain embodiments, such detailed information screens (e.g., 521 and others not shown) may contain additional links to even further detailed information, such as, an AS-i Indicator screen 532 and/or a PLC Indicator screen 533, as shown in FIGS. 7 and 8, respectively. Such screens, together with that of 521, may in certain embodiments further enable operator troubleshooting, as they may be configured to cross-reference particular AS-i module inputs and outputs, AS-i sensor statuses (e.g., on or off), and PLC inputs/outputs/relay outs with the particular item originally selected. In this manner, the system 5 according to various embodiments provides an operator with the tools to identify the precise location of potential issues encountered when preparing to commence refueling activities.

For example, remaining with FIGS. 6-8, upon notification and selection of the “not ready” ignition key icon 512 from the fueling status screen 511 (shown in FIG. 5), an operator wishing to troubleshoot this particular item may first view the ignition key information screen 521, which explains the criteria necessary to become “ready” to commence refueling. If, according to a particular scenario, an operator remains uncertain as to why the item remains unready (e.g., if the ignition key is turned on but the status indicator 502 remains red or “not ready), the system 5 may be configured, according to various embodiments, to permit the operator to then access the AS-i Indicator screen 532 and/or the PLC Indicator screen 533. Such may, in certain embodiments, enable the operator to determine whether a particular module or input/output of the AS-i or PLC, such as a particular sensor, is non-responsive or malfunctioning or even hooked into an incorrect port in the PLC or AS-i, thereby creating a false status indicator 502 for the particular item.

Similarly, referring to FIGS. 5 and 7-8, upon seeing a “not ready” indicator 502 adjacent the static reel deployment icons 567, the system 5 according to various embodiments, would have conveyed to the operator information to the effect that one or more the static reels necessary to bond the aircraft to the refueling vehicle had not been deployed correctly, if at all. Seeing such an indicator 502, the operator could then troubleshoot, as above, to assess whether an AS-i or PLC-based issue is creating a false status indicator and if not, could then subsequently troubleshoot the static reel deployment system via a physical review of the truck and surrounding equipment, as will be described in further detail below.

Help Module 600

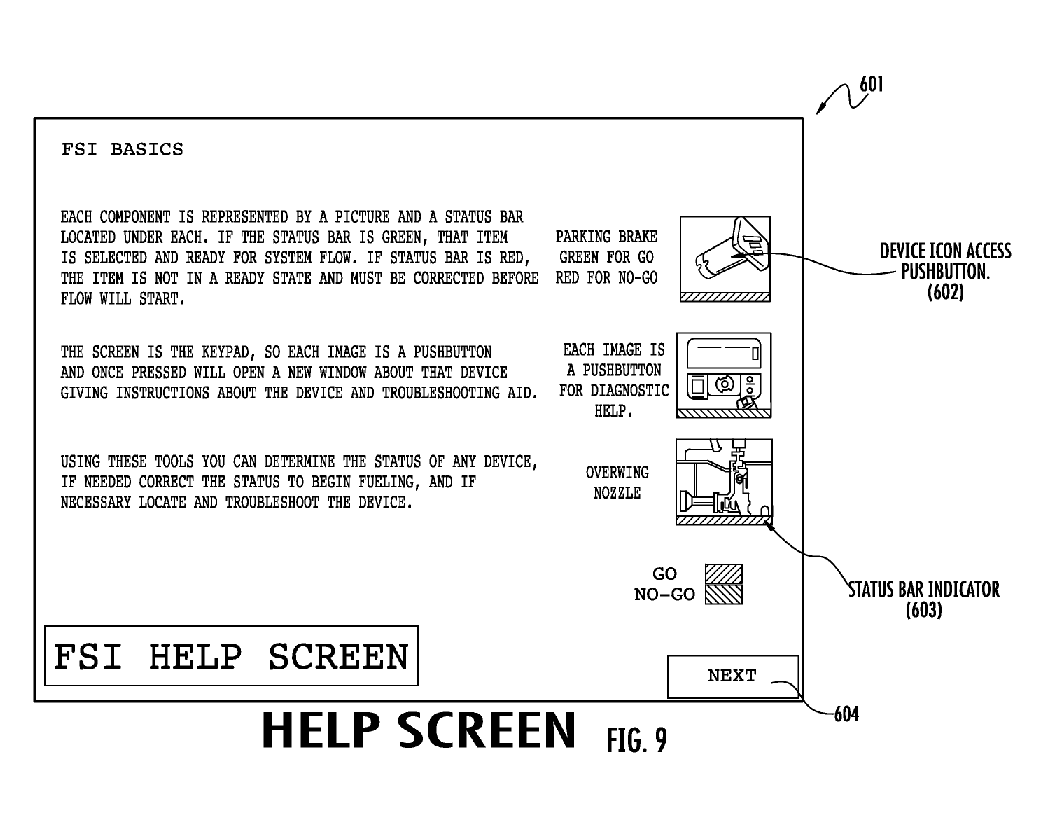

Turning to FIG. 9, a view of a screen display 601 of the help module 600 according to various embodiments is illustrated. As previously introduced, the help module 600 may be configured in various embodiments to convey generally helpful information via a plurality of screens, thereby assisting an operator using the handheld device 120 (and/or the operator control panel 105) to conduct the procedural steps necessary for preparing a refueling truck to commence the refueling process. While, in certain embodiments, such screens may be accessed by an operator during the typical course of performing his or her duties, it is envisioned that, additional and/or alternative embodiments may employ such screens for purposes of training operators, whether in the context of new personnel or due to updated or revised procedures.

As may be best understood from FIG. 9, the screen display 601 of the help module 600 provides broader assistance than the individual icon screens, such as the ignition key information screen 521 of FIG. 6. Indeed, while the latter, according to various embodiments, may be configured to provide detailed information such that an operator may troubleshoot a particular problem or issue when preparing to commence refueling, the screen display 601, along with the other screens available via the help module 600 provide assistance to those operators unfamiliar with how to operate the system 5 itself. For example, in at least certain embodiments, such as that illustrated in FIG. 9, the screen display 601 may convey to an operator how particular safety mechanisms (e.g., the parking brake) may be conveyed as “ready” or “not ready” with an item icon 602 and a status bar indicator 603.

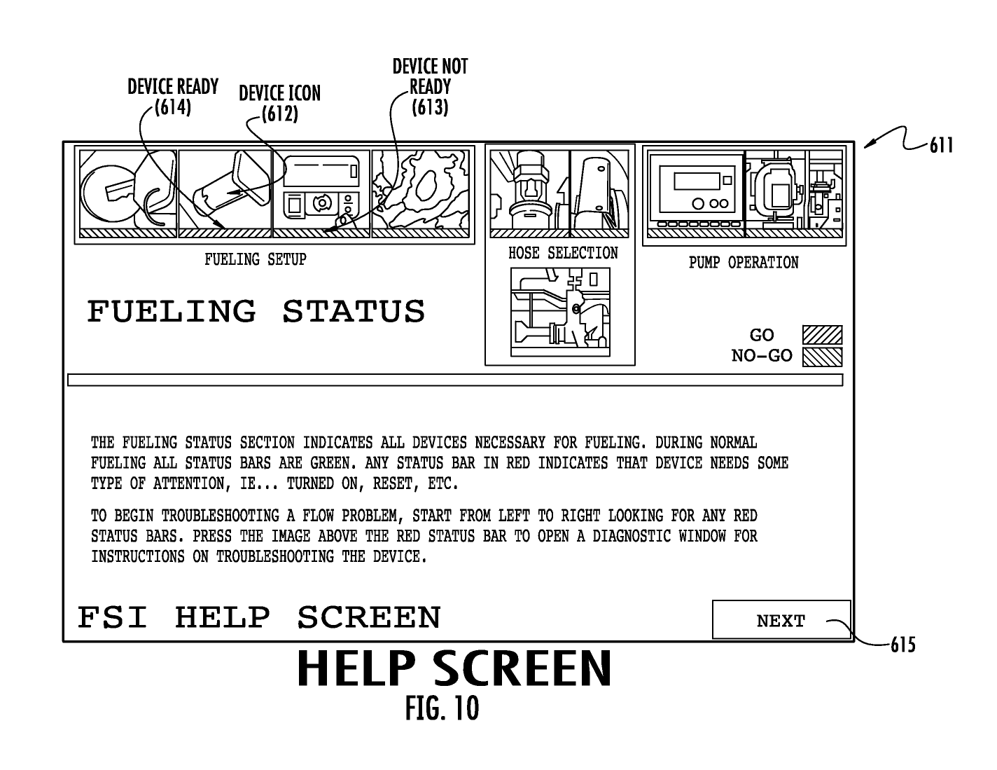

At least certain embodiments of the screen display 601 may also include a navigational button 604 that leads an operator of the handheld device 120 (and/or the operator control panel 105) to one or more detailed screens 611, 661, which convey additionally detailed general help information regarding items associated with a fueling sub-module 610 and a system sub-module 660. At least in certain embodiments, the items for which help is provided in the fueling sub-module 610 and the system sub-module 660 substantially correlate to those items selectable via the fueling sub-module 510 and the system sub-module 560 when an operator is reviewing status indicators 502 of various safety mechanisms in preparation for commencing the refueling process. Such may be best understood from at least FIGS. 10 and 11, which depict screen displays 611 and 661, corresponding generally to screens 511 and 561 accessible via the status module 500 (versus the help module 600).

Still further, in certain embodiments of the screen display 601, the operator may selectively access one or more reports generated by the system 5, as have been previously described herein, to view consolidated status of any of the various safety mechanisms and/or relays, inputs, and outputs of the PLC or AS-I, as have been described previously herein. Such may facilitate not only maintenance and management of the system 5 during use, but also troubleshooting thereof, as described in further detail below.

Troubleshooting Module 700

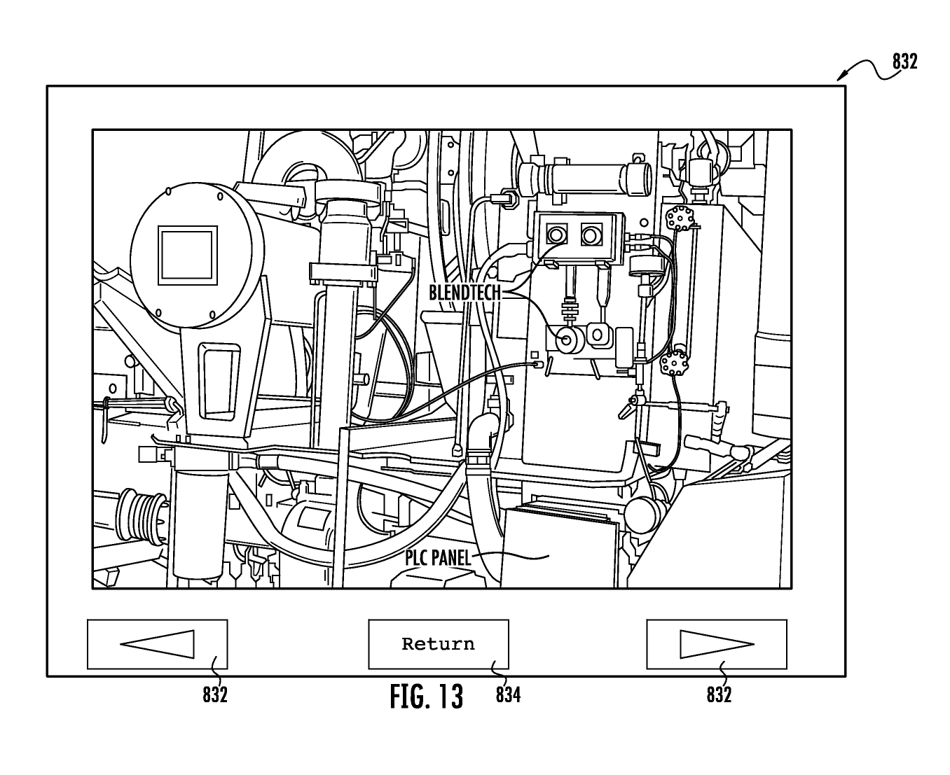

FIG. 12 is a view of yet another screen display 801 of the home module 400 of an operator interface, which according to various embodiments may further include a troubleshooting module 700. In certain of these embodiments, the home module 400 may be configured substantially the same as previously described, but for the addition of a third selectable (e.g., touch-sensitive) button 830, alongside buttons 810 and 820 (likewise analogous to buttons 410 and 420). In these and still other envisioned embodiments, the button 830 may be configured to communicate with the troubleshooting module 700, such that when an operator touches, presses, or otherwise activates the button, a screen display associated with the troubleshooting module 700 appears, as may be seen in, for example, FIGS. 13-17, and as described in further detail below. It should be understood that, as with the previously described modules, the troubleshooting module 700 may be accessed by an operator via the handheld device 120 and/or the operator control panel 105 located on the refueling truck 100.

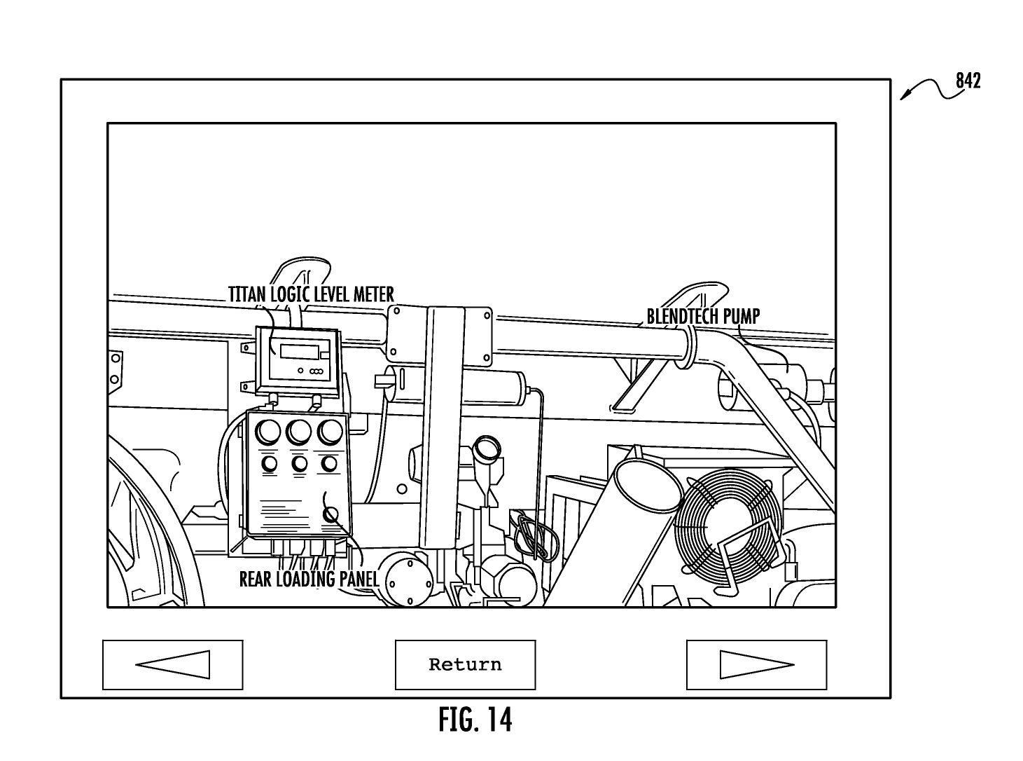

Turning now to FIG. 13, there is depicted according to various embodiments a first image screen 832 accessible via the screen display 801 of FIG. 12. In certain embodiments, such may be accessed by an operator using the system 5, and in particular the handheld device 120 when seeking to troubleshoot an item that is physically located on the refueling truck itself. In other embodiments, such may be accessed in response to an operator being notified that a particular item is “not ready” prior to commencing a particular refueling process. In these and other embodiments, the image screen 832 (and comparable screens of FIGS. 14-16) may be accessed to assist the operator with identifying the exact physical location of the item (e.g., device or sensor) on the truck itself. Indeed, according to various embodiments, the image screen 832 (and other comparable screens, as will be described in further detail below) is configured to display a visual representation of a particular safety mechanism. In certain embodiments, the visual representation is a visual depiction of the physical location of the safety mechanism relative to the refueling truck. In at least one embodiment, the visual representation is a photo or image of the safety mechanism and at least some portion of the refueling truck for purposes of contextual location. Of course, in any of these and in still other embodiments, the image screen 832 may be accessed in conjunction with and/or via any of the particular item information screens, such as, for example, the ignition key information screen 521, as previously described herein.

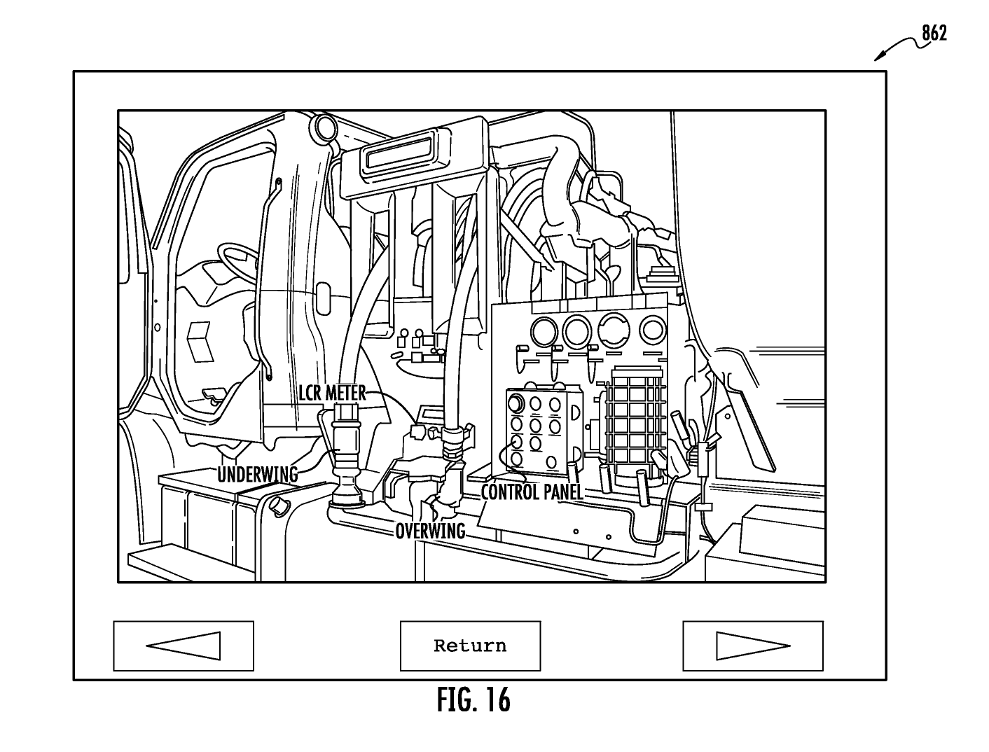

Referring collectively to FIGS. 13-16, a variety of non-limiting exemplary image screens 832, 842, 852, and 862 may be accessed according to various embodiments by the operator using the handheld device 120. In certain embodiments, the screens may be accessed via the home screen display 401, while in other embodiments they may be accessed via any of the item information screens (e.g., 521), as previously discussed. In any of these and still other embodiments, the image screens may be configured with a selectable return button (e.g., 834) that permits the operator to return to the previously viewed screen upon physical location of the item (e.g., the static reel of FIG. 15 or the over-wing nozzle of FIG. 16). As previously described herein, each of the exemplary image screens 832, 842, 852, and 862 may be configured to display a visual representation of a particular safety mechanism. In certain embodiments, the visual representation is a visual depiction of the physical location of the safety mechanism relative to the refueling truck. In other embodiments, the visual representation is a photo or image of the safety mechanism and at least some portion of the refueling truck for purposes of contextual location. Of course, in still other embodiments, the visual representation may be any of a variety of illustrations or depictions, provided such sufficiently convey to the operator the location of the safety mechanism relative to at least a portion of the refueling truck.

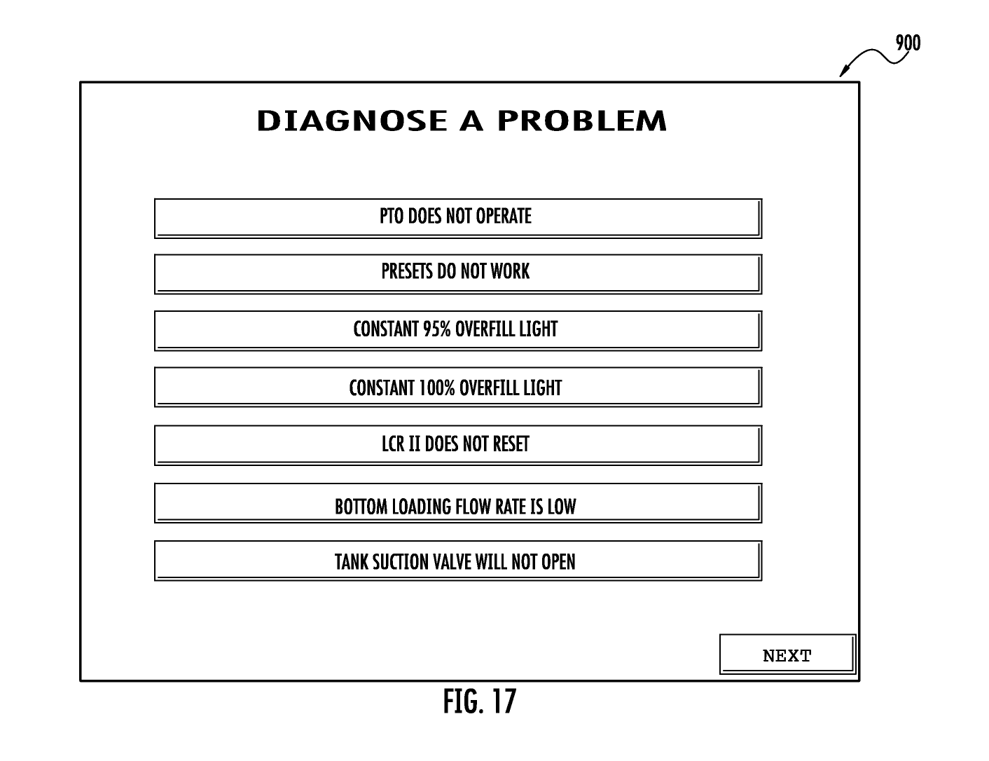

In still further various embodiments, the troubleshooting module 700 may be configured to permit a user or operator to access a main diagnosis screen 900, from which the user or operator may select one of a plurality of commonly encountered issues or problems, as generally illustrated FIG. 17. For purposes of a non-limiting example, an operator having identified an issue with the LCR meter, whether independently or by observing a “not ready” status indicator 502 (see FIG. 5) adjacent the LCR meter icon 514 on the screen display 501 of the status module 500, may select the icon, thereby displaying on the handheld device 120 a new screen conveying additionally detailed information regarding the meter settings (see, by analogy, the ignition key information screen 521, as illustrated in FIG. 6). If the detailed information proves insufficient for solving the identified issue or problem, instead of calling a third party helpdesk or any of a variety of envisioned and commonly known remote entities for further assistance, the operator may instead access the troubleshooting module 700 and, in to a degree, put on his or her “mechanic hat.”

In this manner, returning to FIG. 17, the system 5 may, according to those various embodiments including the troubleshooting module 700, be configured to display the main diagnosis screen 900, from which the operator can select, as a non-limiting example the “LCR II does not reset” button. Selection of the “LCR II does not reset” button may, in certain embodiments, then display the image screen 862, detailing the relative physical location of the LCR meter upon a standard refueling truck. Upon location of the same by the operator, the system 5 according to these and other embodiments may be configured to permit the operator to return to a previous display screen (via, for example, the return button 834 of FIGS. 13-16). In at least one embodiment, the system 5 may be configured to return to the main diagnosis screen 900, while in still other embodiments, the system may be configured to return instead to either the screen display 501 of the status module 500 or the previously selected icon item screen (e.g., a screen associated with the LCR meter icon 514, as previously discussed herein).

While the main diagnosis screen 900 may, according to certain embodiments, be configured substantially as shown in FIG. 17, it should be understood that any of a variety of configurations may be envisioned, including the non-limiting examples of a plurality of thumbnail previews of common issues, a selectable indexed table of contents, and/or a searchable menu. In at least one embodiment, the main diagnosis screen 900 may include multiple screens, although in other envisioned embodiments, the interface may be minimized to a single screen.

### CONCLUSION

Many modifications and other embodiments of the invention set forth herein will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A control system for facilitating remote troubleshooting of one or more safety mechanisms associated with a flow of liquid fuel from a refueling vehicle to an aircraft, the system comprising:
one or more memory storage areas; and
one or more computer processors configured for:
(A) receiving and storing in the one or more memory storage areas data associated with one or more safety mechanisms;
(B) using at least a portion of the data to determine whether one or more parameters associated with the one or more safety mechanisms have been satisfied;
(C) generating a status for one or more selectable status indicators associated with the one or more safety mechanisms, the one or more selectable status indicators being based at least in part upon the determination of whether the one or more parameters have been satisfied; and
(D) in response to receiving a selection of one of the one or more selectable status indicators, displaying a visual representation of a particular safety mechanism associated with the selected status indicator, wherein the visual representation comprises an image representing at least a physical location of the particular safety mechanism relative to the refueling truck so as to facilitate remote troubleshooting of the particular safety mechanism.

2. The control system of claim 1, wherein the visual representation is a visual depiction of the particular safety mechanism.

3. The control system of claim 2, wherein the visual depiction comprises a representative photograph.

4. The control system of claim 1, wherein the visual representation of the particular safety mechanism associated with the selected status indicator further comprises textual data associated with the particular safety mechanism.

5. The control system of claim 4, wherein the textual data is accessible via a selectable icon.

6. The control system of claim 1, wherein, in response to receiving the selection of one of the one or more selectable status indicators, the one or more computer processors are further configured for displaying a diagram indicating at least a status of at least one or more relays, inputs, and outputs of the control system so as to further facilitate remote troubleshooting of the particular safety mechanism.

7. The control system of claim 6, wherein:
the at least one or more relays, inputs, and outputs of the control system are associated with at least one of a programmable logic controller (PLC) and an actuator sensor interface (AS-i); and
the PLC and the AS-i are configured to communicate with one or more sensors associated with the one or more safety mechanisms.

8. The control system of claim 7, wherein the one or more sensors are selected from a group consisting of: a vehicle accessory sensor, a vehicle engine management sensor, a static reel sensor, a vehicle leveling sensor, a handrail location sensor, an ignition key activation sensor, a parking brake activation sensor, an Inductance/Capacitance/Resistance (LCR) meter sensor, a hose selection sensor, hose & nozzle proximity sensor, a fuel pump pressure sensor, a fuel pump RPM sensor, and a fuel pump liquid sensor.

9. The control system of claim 7, wherein a status of the one or more sensors is conveyed as “not ready” when one or more of the one or more safety mechanisms have not been properly configured to commence refueling.

10. The control system of claim 7, wherein a status of the one or more sensors is conveyed as “not ready” when one or more of the sensors associated with the one or more safety mechanisms have malfunctioned.

11. The control system of claim 7, wherein a status of the one or more sensors is conveyed as “not ready” when one or more of the sensors is in an error state.

12. The control system of claim 11, wherein the error state occurs due to the one or more sensors being at least one of unplugged from the PLC or AS-i port or plugged into an incorrect port of the PLC or AS-i.

13. The control system of claim 7, wherein:
at least one of the one or more sensors is a hose & nozzle proximity sensor;
the one or more parameters are configured such that the selectable status indicator conveys a status of the sensor as “not ready” when a hose of the refueling vehicle has not be properly positioned adjacent the aircraft; and
the one or more parameters are configured such that the selectable status indicator conveys a status of the sensor as “ready” when the hose has been properly positioned.

14. The control system of claim 1, wherein, in response to receiving the selection of one of the one or more selectable status indicators, the one or more computer processors are further configured for displaying a plurality of selectable icons, each of the plurality of selectable icons being configured to provide data associated with frequently asked questions regarding the particular safety mechanism associated with the selected status indicator so as to further facilitate remote troubleshooting of the particular safety mechanism.

15. The control system of claim 1, wherein the one or more selectable status indicators convey a status of the associated safety mechanism as either “ready” or “not ready.”

16. The control system of claim 15, wherein:
the “ready” status is conveyed visually by at least a portion of the selectable status indicator being color-coded a green color; and
the “not ready” status is conveyed visually by the portion of the selectable status indicator being color-coded a red color.

17. The control system of claim 16, wherein the “not ready” status of the associated safety mechanism is further conveyed at least one of audibly and textually.

18. The control system of claim 15, wherein:
the particular safety mechanism is a parking brake activation sensor;
the one or more parameters are configured such that the selectable status indicator conveys a status of the sensor as “not ready” when a brake of the refueling vehicle has not been set; and
the one or more parameters are configured such that the selectable status indicator conveys a status of the sensor as “ready” when the brake has been set.

19. A computer-implemented method for facilitating remote troubleshooting of one or more safety mechanisms associated with a flow of liquid fuel from a refueling vehicle to an aircraft, said method comprising the steps of:
(A) receiving and storing data in one or more memory storage areas, said data comprising data associated with one or more safety mechanisms;
(B) using at least a portion of the data to determine, via at least one computer processor, whether one or more parameters associated with the one or more safety mechanisms have been satisfied;
(C) generating, via the at least one computer processor, a status for one or more selectable status indicators associated with the one or more safety mechanisms, the one or more selectable status indicators being based at least in part upon the determination of whether the one or more parameters have been satisfied; and
(D) in response to receiving a selection of one of the one or more selectable status indicators, displaying a visual representation of a particular safety mechanism associated with the selected status indicator, wherein the visual representation comprises at least a physical location of the particular safety mechanism relative to the refueling truck so as to facilitate remote troubleshooting of the particular safety mechanism.

20. The computer-implemented method of claim 19, wherein:
in response to receiving the selection of one of the one or more selectable status indicators, the one or more computer processors are further configured for displaying a status of at least one or more relays, inputs, and outputs;
the at least one or more relays, inputs, and outputs of the control system are associated with at least one of a programmable logic controller (PLC) and an actuator sensor interface (AS-i); and
the PLC and the AS-i are configured to communicate with one or more sensors associated with the one or more safety mechanisms so as to further facilitate remote troubleshooting of the particular safety mechanism.

21. The computer-implemented method of claim 20, wherein a status of the one or more sensors is conveyed as “not ready” when one at least one of the following occurs:
one or more of the one or more safety mechanisms have not been properly configured to commence refueling;
one or more of the sensors associated with the one or more safety mechanisms have malfunctioned; and
one or more of the sensors is in an error state, wherein the error state occurs due to the one or more sensors being at least one of unplugged from the PLC or AS-i port or plugged into an incorrect port of the PLC or AS-i.

22. The computer-implemented method of claim 20, wherein the one or more sensors are selected from a group consisting of: a vehicle accessory sensor, a vehicle engine management sensor, a static reel sensor, a vehicle leveling sensor, a handrail location sensor, an ignition key activation sensor, a parking brake activation sensor, an Inductance/Capacitance/Resistance (LCR) meter sensor, a hose selection sensor, hose & nozzle proximity sensor, a fuel pump pressure sensor, a fuel pump RPM sensor, and a fuel pump liquid sensor.

23. The computer-implemented method of claim 22, wherein:
at least one of the one or more sensors is a hose & nozzle proximity sensor;
the one or more parameters are configured such that the selectable status indicator conveys a status of the sensor as “not ready” when a hose of the refueling vehicle has not be properly positioned adjacent the aircraft; and
the one or more parameters are configured such that the selectable status indicator conveys a status of the sensor as “ready” when the hose has been properly positioned.

24. The computer-implemented method of claim 23, wherein:
the “ready” status is conveyed at least visually by at least a portion of the selectable status indicator being color-coded a green color; and
the “not ready” status is conveyed at least visually by the portion of the selectable status indicator being color-coded a red color.

25. The computer-implemented method of claim 19, wherein, in response to receiving the selection of one of the one or more selectable status indicators, the one or more computer processors are further configured for displaying a plurality of selectable icons, each of the plurality of selectable icons being configured to provide data associated with frequently asked questions regarding the particular safety mechanism associated with the selected status indicator so as to further facilitate troubleshooting of the particular safety mechanism.

26. A control system for facilitating a flow of liquid fuel from a refueling vehicle to an aircraft, the system comprising:
one or more memory storage areas; and
one or more computer processors configured for:
(A) receiving and storing in the one or more memory storage areas data associated with one or more sensors;
(B) using at least a portion of the data to determine whether one or more parameters associated with the one or more sensors have been satisfied;
(C) generating a status for one or more selectable status indicators associated with the one or more sensors, the one or more selectable status indicators being based at least in part upon the determination of whether the one or more parameters have been satisfied; and
(D) in response to receiving a selection of one of the one or more selectable status indicators, displaying a status of at least one or more relays, inputs, and outputs associated with at least one of a programmable logic controller (PLC) and an actuator sensor interface (AS-i) configured to communicate with the one or more sensors and facilitate a flow of liquid fuel.

27. The control system of claim 26, wherein the one or more sensors are selected from a group consisting of: a vehicle accessory sensor, a vehicle engine management sensor, a static reel sensor, a vehicle leveling sensor, a handrail location sensor, an ignition key activation sensor, a parking brake activation sensor, an Inductance/Capacitance/Resistance (LCR) meter sensor, a hose selection sensor, hose & nozzle proximity sensor, a fuel pump pressure sensor, a fuel pump RPM sensor, and a fuel pump liquid sensor.

28. The control system of claim 26, wherein a status of the one or more sensors is conveyed as “not ready” when one at least one of the following occurs:
one or more of the sensors associated with the one or more safety mechanisms have malfunctioned; and
one or more of the sensors is in an error state, wherein the error state occurs due to the one or more sensors being at least one of unplugged from the PLC or AS-i port or plugged into an incorrect port of the PLC or AS-i.

29. The control system of claim 26, wherein, in response to receiving the selection of the one of the one or more selectable status indicators, the one or more computer processors are further configured for displaying a visual representation of a particular safety mechanism further associated with the selected status indicator, wherein the visual representation comprises an image representing at least a physical location of the particular safety mechanism relative to the refueling truck so as to facilitate remote troubleshooting of the particular safety mechanism.

30. The control system of claim 29, wherein:
the visual representation comprises a representative photograph of the particular safety mechanism; and
the selected status indicator further comprises textual data associated with the particular safety mechanism, the textual data being accessible via a selectable icon.
